(19) United States
(12) Patent Application Publication
(10) Pub. No.: US 2016/0161050 A1
(43) Pub. Date: Jun. 9, 2016

(54) TRIPOD WITH A SINGLE AND FOLD FOOTPRINT

(71) Applicant: blue object oHG, Hamburg (DE)

(72) Inventors: Kai Trebesius, Rehhorst (DE); Armin Müller, Hamburg (DE)

(73) Assignee: blue object oHG, Hamburg (DE)

(21) Appl. No.: 14/647,661

(22) PCT Filed: Nov. 28, 2013
(86) PCT No.: PCT/EP2013/074994

§ 371 Date: Feb. 22, 2016

(30) Foreign Application Priority Data
Nov. 28, 2012 (DE) 10 2012 023 162.8

(51) Int. Cl. F16M 11/24; F16M 11/42; F16M 11/38; F16M 11/14

(52) U.S. Cl. CPC F16M 11/245; F16M 11/14; F16M 11/42; F16M 11/38

(57) ABSTRACT

Stand having a standing area that can be folded in and out, including a handle to lift the stand with one hand, whereby a folding in and/or folding out of the standing area can be activated within a grasping area that is reachable with one hand grasping said handle.

The invention includes a stand having a standing area that can be folded in and out. These sorts of stands are used for placing different objects, for instance cameras, notes, spotlights and so on. In folded out state, the relatively large standing area enables a solid standing position for the stand. It can be carried easily in collapsed state.

These sorts of stands have been known for a long time, e.g. the publication DE 80 700 A includes telescoped tubes consisting of paper-based material. There are three swiveling legs that are linked to a block and can be inserted into the inner tube.

The publication DE 69 33 480 U shows a stand with a cylindrical casing and three legs that are linked to a block, which is adjustably stored in the casing. The unattached ends of the legs go through openings in the casing. After activating an unlocking mechanism that is positioned at the lower end of the cylindrical casing, the legs can be extended into a folded out position.

The publication DE 1 926 452 U shows a stand with a central tube that is interlocked with three elements. Three legs each are hinged at two gliding bearing blocks on the lowest tube section. They can be folded in a place-saving way into the lowest tube section.

The publication CH 27 607 A also shows a stand with a central tube and three foldout legs hinged to it. The upper ends of the legs are hinged on a case that surrounds the central tube adjustably and can be fixed with an adjusting screw. After loosening the adjusting screw the case can be displaced to fold the legs in and out.

The publication US 2012/0132764 A1 shows a stand with a clamp device to hold an electronic device.

Based on this state of the art, the function of the invention is to provide a stand having a standing area that can be folded in and out that enables a frequent change in an easy way between solid depositing which means a folded out standing area, and place-saving carrying which means a folded in standing area.

This problem is being solved by the stand's feature according to claim 1. Advantageous embodiments are named in the following subclaims.

The stand has a standing area that can be folded in and out and a handle to lift the stand with one hand, whereby the folding in and out of the standing area can be activated by a grip with one hand on the grasping area.

In folded in state the stand can be carried easily. Particularly the horizontal dimensions of the stand are reduced compared to the folded out state. Therefore the user can change the location easily while carrying the stand. Especially it is no problem to pass a doorframe as well as walking in between two chairs without bumping into them.

The stand can be lifted with one hand when grabbing the handle. The handle can have an ergonomic form but it can also just be a tube section of the stand that can be grabbed comfortably. To provide a comfortable grip from all sides, the handle can advantageously be formed more or less rotationally symmetric around the vertical axis of the stand. The now mentioned and following usage of the words upper, lower, vertical, horizontal etc. are relating to a normal standing position of use of the stand.

The grasping area is reachable with one grabbing hand. This means, the user who grabs the handle with just one hand to lift the stand can reach the grasping area and especially an actuation element that is located inside it, without releasing the handle. This can be achieved with just one or more fingers, particularly with the thumb.

The user is able to activate the folding in and out of the standing area in the grasping area. For this purpose, the user can activate an actuation element that is located in the immediate vicinity of the handle, e.g. directly above it. Alternatively the user can make simply one certain move, e.g. lifting or rotating the handle, and thereby activate the folding in or out of the standing area. The elements that activate the folding in and out of the standing area are located in the grasping area so that—in an advantageous embodiment—the standing area is folding in while lifting up the stand on the handle as well as it can be folded out while depositing the stand without letting go of the handle, changing the hand's position or using another hand. Therefore the other hand remains free for other tasks.

In one embodiment folding in the standing area is activated automatically while lifting the stand on the handle. That means that the user does not have to take any further actions except for lifting up the stand on the handle to fold in the standing area.

In one embodiment an electric or mechanic switch is located in the grasping area to trigger the folding in and/or folding out of the standing area. The electric or mechanic switch can be formed in a way that it is activated automatically while lifting the stand on the handle. Alternatively the handle can be actuated e.g. with the user's thumb without lifting the stand on the handle.

In one embodiment the stand features a stand section with one leg that remains on the floor while lifting the stand on the handle whereby a movement of the stand section relatively to the handle activates the folding in and out of the standing area. The leg can form the lowest position of the stand when the standing area is in folded out state. In this case the leg firstly touches the floor, which leads to a relative movement of the stand section with the leg to the handle so that a further downward movement of the handle activates the folding out of the standing area. While lifting the stand on the handle the leg remains on the floor at first and through the relative movement folding in the standing area is activated. The leg, the section of the stand or an element in between them can be formed elastically so that the folded out standing area, when letting go of the handle, can sink to the bottom in such a way to make the stand stand solidly on the standing area by means of the weight of the stand and if applicable by means of an attached device. In this case only a small part of the weight force is passed into the floor through the leg.

In one embodiment the handle is movable and formed to fold in the standing area while lifting the stand on the movable handle. This folding in can also be achieved automatically while lifting the stand, which means without any other steps for the user. The movable handle can, like the previous explained handle, be formed ergonomically or it can be built for instance out of a different, easy to grab section of the stand, such as a tube. In this embodiment a relative movement of the handle to another element of the stand leads to the folding in and/or folding out of the standing area.

In one embodiment the stand features a device fixing to carry a device and a main column, where the handle is located in the area of the main column. The handle is preferably located on the upper end of the main column and/or near the device fixing or near a transition area between them. Since a device that is carried by the stand is usually arranged in a way that makes it easy to reach for the user, in this case a very good reachability of the handle is achieved.

In one embodiment the stand features a guideway in which the movable handle moves in a way that the stand remains on the floor and the movable handle moves relatively to the stand at first when lifting the stand on the movable handle. The relative movement takes place between the movable handle and any other element of the stand, e.g. to the main column or simply to another different element in the inner stand. The guideway can feature an upper limit stop that limits the movement of the movable handle upwardly so that the whole stand is lifted by a further upward movement.

In another embodiment the movable handle is formed to exert driving force while moving the movable handle relatively to the stand to achieve the folding in of the standing area. This applies especially to an upward movement of the handle. At a downward movement of the movable handle relatively to the stand, a driving force can accordingly be exerted to achieve the folding out of the standing area.

In one embodiment a first switch is given that activates the folding in of the standing area utilizing electrics and/or electronics while the movement of the movable handle relatively to the stand is activated. The first switch is located in such a way that the movable handle or an attached actuation element can activate it automatically. By means of the use of an electric drive, if applicable in combination with an electronic control system, the forces needed for activating the detraction and the forces that exert on the movable handle can be minimized. This favors a trouble-free use of the stand even in a very lightweight configuration and/or with very lightweight devices.

In one embodiment the standing area folds out when letting go of the movable handle. To this the stand and/or any attached device can be grabbed at any spot so that the standing area can be folded out completely before the stand is put down on the floor.

In one embodiment the stand features a second handle on which the stand can be held to fold out the standing area or to keep it in a folded out state. This enables amongst other things a very easy shift of the stand within short distances where otherwise a detraction of the standing area could be unnecessary or obstructive.

In one embodiment the second handle is located above the movable handle. In this case the user, who lifted and if applicable carried the stand at the movable handle, can change the grip easily to the second handle by letting go of the first handle and/or loosening the grip until the second handle is located in the hand and can be held easily. A change from the movable handle to the second handle (that in the following is described as solid handle) therefore is especially easy, fast and unremarkable. It enables the user to carry the stand with folded in standing area and to fold out the standing area and to put it down softly in one more or less fluid movement.

In one embodiment the second handle features a larger maximum diameter than the movable handle. This simplifies the grabbing of the second handle after loosening the movable handle.

In one embodiment a second switch exists whose actuation activates the folding out of the standing area. Said second switch can also be mechanical or electric. The second switch allows to fold out the standing area precisely at the desired location.

In one embodiment the second switch is an annular switch that is located ring-shaped around the main column of the stand. In this case the second switch can be activated easily, regardless of the side where the stand is grabbed. An actuation of the annular switch can be intended by means of an axial movement, which means by sliding the annular switch up and down or by a lateral/radial or tangential movement of the annular switch.

In one embodiment the second switch is ring-shaped and features a plurality of primarily radial protruding actuation sections. By ‘primarily radial protruding’ is meant that the actuation sections reach from one radius location that is near to an axis of symmetry of the switch to a second radius location that is more distant. In this embodiment the actuation of the switch is intended by means of a rotary movement, which means a movement based on the ringshape of the switch into tangential direction. The actuation sections are particularly suitable to exert a force in this direction. Especially easy is the actuation with the thumb whereby the thumb can be put on both of the sides of the actuation sections so that a movement in both directions can be conducted. Three to eight, in one advantageous embodiment four actuation sections can be formed on the switch. The actuation sections can also be formed out of ridges that are located between finger recesses. This sort of second switch can advantageously be used to activate height adjustment. The second switch can as well be used for any other function, such as folding out the standing area.

In one embodiment the second switch is located above the handle so that it is reachable for the thumb of the hand that grabs the handle. In other words, the switch can be located in the grasping area so that it can be activated without a change of the hand's position. In one advantageous embodiment this handle can be the movable handle.

In one embodiment the main column features a supporting profile arrangement that supports a device that is located on the stand as well as a controlling profile arrangement that transfers a force to the standing area to make it fold in and/or fold out. The supporting profile arrangement can reach in particular from a device fixing to a connection to the standing area that can be folded in and out. It can consist of a single profile such as a tube, or a combination of several profiles that are connected with each other, in order to carry a device that is located on top of the stand. The controlling profile arrangement can also consist of a single profile or several profiles and can reach from the grasping area, for instance from an electrical or mechanical switch that is located in the grasping area or from a nearby located handle to a control mechanism for the standing area or to the standing area itself. In particular the controlling profile arrangement can be located in the inside of the supporting profile arrangement or the other way around.

In one embodiment the supporting profile arrangement features two profiles that are coupled with each other by friction. By means of the friction coupling a sufficient load capacity is achieved. At the same time a height adjustment of the main column can be reached by overcoming the friction through exerting corresponding forces by hand. Basically two profiles of the supporting profile arrangement can be coupled in a different way, for instance by means of a mechanically switchable connection or by form locking, for example through the cooperation of a gear rack and a pawl that engages to the gear rack. It is also possible to form the coupling of both of the profiles switchable by friction, which means to either press or detach the coupled profiles against/from each other, in one advantageous embodiment by arranging a friction coating in between two areas that are pressed against each other.

In one embodiment the controlling profile arrangement is formed to exert forces in vertical direction without exerting forces in horizontal directions to other elements of the stand. In this way additional friction forces between the controlling profile arrangement and the supporting profile arrangement can be avoided and the folding mechanism is especially effortless.

In one embodiment the controlling profile arrangement features two profiles and a mechanical connection device that enable to connect and detach the two profiles from each other. In this case the length of the controlling profile can be adjusted easily by adjusting the height of the stand, respectively of the main column. Basically, a coupling of two profiles of the controlling profile arrangement by friction can be realized instead of a mechanical connection device as mentioned previously referring to the supporting profile arrangement. This friction coupling can also be realized in a switchable way.

In one embodiment the connection device features a gear rack and a pawl that engages to the gear rack. To connect both of the profiles of the controlling profile arrangement with each other, the pawl can be brought into contact with the gear rack. To detach both of the profiles from each other, the contact can be repealed. For this purpose, the connection device can be used. This leads to an easy and reliable adjustment of length of the controlling profile arrangement, especially when adjusting the length of the main column.

In one embodiment the connection device features a pole and a clamping ring. To connect both of the profiles of the controlling profile adjustment with each other, the clamping ring can be positioned clamping to the pole. The clamping ring can be positioned in such a way that the clamping effect under load, especially under tensile stress, is increasing. This allows a stepless height adjustment.

In one embodiment the pawl, respectively the clamping ring is connected with the movable handle through one or several hinges and rests in the lowest position of the movable handle on a protrusion that removes the pawl from the gear rack, or respectively the clamping ring from the pole. In this case the engagement between pawl and gear rack, respectively between clamping ring and pole is repealed automatically when letting go of the movable handle and when the movable handle is located in its lowest position relative to the stand, respectively to a main column of the stand. An easy height adjustment of the stand is then possible, for example by moving up an upper portion of the stand by grasping a different element than the movable handle relatively to a lower portion of the stand. The length of the controlling profile arrangement adjusts automatically.

In one embodiment the controlling profile arrangement is rotatable with respect to the supporting profile arrangement and the folding in and/or folding out can be activated by means of a rotary motion of the controlling profile arrangement with respect to the supporting profile arrangement.

It is clear that either the supporting profile arrangement or the controlling profile arrangement can be connected to the handle so that the rotary motion can be done through a movement of the handle. Thereby the handle can either be rotated, or a vertical movement of the handle can be transformed—e.g. by a slotted link—into a rotary movement of the controlling, respectively the supporting profile arrangement.

In one arrangement the standing area is formed by legs that can be folded in and out. Basically, a solid position of the stand can also be achieved without such legs, for example by using a plate as standing area that is brought into a horizontal state when being folded out and that is brought into a vertical state when being folded in. It is also possible to use a divided plate as a standing area so that two halves of the plate are being moved back and forth between a vertical and a horizontal state when they are folded out or in. The use of legs, especially of three legs, allows a particularly compact shape of the standing area in folded in state and offers a solid position in folded out state of the stand at the same time.

In one embodiment the legs can be folded in and out with help from magnetic forces from electro and permanent magnets. The electro and permanent magnets can exert an attractive force immediately onto a magnetizable part of the legs. A usage of repelling forces is also possible provided that more magnets with the opposite polarity are inserted at the legs.

In one embodiment the legs feature wheels or castors on the outer ends. The rotation axis of the wheels or castors can be arranged horizontally. Each rotation axis can be arranged vertically to a longitudinal axis of the related leg. The wheels and castors can protrude in such a way that they can roll down on vertical surfaces. The wheels and castors promote a folding in and out of the legs especially when the free ends of the legs have contact with the floor while folding in or out, particularly on uneven floors or carpets. The possibility to roll down on vertical surfaces can additionally avoid a damage of furniture or other objects.

In one embodiment the fixing device features a magnetic ball joint. More particularly this can feature a magnetizable ball and a permanent magnetical base. By means of the attractive forces between ball and base, the position of the ball joint and therefore the arrangement of a device that is fixed on the fixing device can be adjusted easily by overcoming the friction between ball and base.

Subsequently, the invention is explained once more by using partly divergent terms and on the basis of embodiments.

Widely known are stands, e.g. for cameras that consist of three telescopically insertable legs that are fixed directly as well as additionally through struts that are foldable inwards on a center column. Often the height of the center column is adjustable and the above fixed fixing device, e.g. by means of a multiple joint is rotatable in several directions.

For musical purposes lightweight, collapsible music stands are widespread. They connect the long center column with short, rather flat standing legs.

From US 2012/0132764 A1 a stand became known for fixing an indicating device. This stand includes a clamping mechanism for the device that is connected with the rest of the stand through a ball joint.

If you want to fix for example a tablet computer on a conventional stand and if you want to take it with you to change for example the place of work in an industrial building you will notice that the transport of a stand that is not collapsible is uncomfortable, because you will bump into everything and you will not be able to pass smaller passages. Furthermore—e.g. in a car dealership—the bumping into objects can cause extremely costly damage. Therefore it seems likely to fold in the stand for the change of application site.

To fold in and out conventional stands it is necessary to actuate—sometimes several—control elements. They are located in positions of the stand that sometimes are distant from the area where you can carry it. Furthermore they are often only easy to use from one side so that you either have to move the stand or you have to walk around the stand. If you want to lift the stand you have to make a decision on which element it is supposed to be carried. Depending on the choice of the element the transport is often not comfortable or even dangerous (risk of entrapment), or it turns out while lifting the stand that the center of gravity is disadvantageous so that the transport becomes unnecessarily stressful. If you managed to set up the stand you will need several control elements once again in different places to bring the device into the desired position. Through complex movements and mutual interference of the adjustment procedures you get the result that the position of the device is not intuitively predictable so that you have to repeat the adjustment several times until it is positioned the way you want it to be.

By means of the plurality of visible elements that are made of different materials the conventional stands appear optically agitated so that it is not attractive to have it constantly in your field of vision e.g. in an apartment.

The invention is based on the task to create a stand that is ergonomically optimized for the frequent change between solid positioning and space saving carrying as well as an intuitive adjustment of the device's position. At the same time a simple appearance should be rendered possible.

This task is being solved by a mechanism according to patent claim 1. Advantageous embodiments are found in the dependent claims, in the description as well as in the drawings.

The provision intends to create a grasping area at the stand that offers a handle for lifting as well as the possibility to fold in the standing area with one hand only. In one advantageous embodiment the folding in is activated automatically while lifting the stand.

A correspondent grasping area (that is identical with said grasping area in the optimal way) exists for folding out the standing area and for the placing of the stand.

A suitable position for such grasping area is located in the area of the column that connects the transition to the fixing device with the folding mechanism of the standing area (here: main column).

This allows e.g. a cylindrical handle that surrounds the column so that the handle can be used from any direction equally well. It is also advantageous to locate it in the vicinity of the device, because the user often chooses the device's position in such a way that the operation is comfortable.

The grasping areas can also include switches to activate the desired function. These can also be realized with the abovementioned advantages, e.g. as an annular switch that surrounds the column. Such an annular switch can also be integrated in a handle.

The easiest way to achieve a change of the standing area—as in the conventional stands—is reached by means of folding in and out legs. Other possibilities are also conceivable, e.g. a standing plate that is pivoted vertically by 90 degrees or a standing plate that is divided in the middle and whose halves can be folded up. To simplify, it is spoken of legs instead in the following.

An automatical activation of the folding in of the standing area can be achieved for instance by means of a handle for lifting that moves in a guideway of the stand which allows a certain vertical shift. If the user now lifts the handle, the stand remains at the same place at first, until the handle has reached the upper end of the guideway and only then the stand is lifted. The movement of the handle with respect to the stand can be used as driving force for folding in the legs or—in another embodiment—as a switching travel to trigger this function.

Another embodiment according to the invention features a special leg that can be located e.g. in the middle under the main column and that remains on the floor at first until it also gets lifted. As with the abovementioned movable handle this differential motion can be used mechanically or electronically to activate the folding in of the legs.

A special advantage of this solution is that the leg—with corresponding geometry of the leg mechanics—can also control the countermovement, which means that it can control the folding out of the legs automatically while depositing the stand.

When using electrics and electronics it can be advantageous to determine the distance to the floor with a sensor.

If you use the lifting of the handle with respect to the stand as a trigger for folding in the legs it appears obvious to use the releasing of the handle as a trigger for folding out the legs. Advantageously, folding out the legs takes place while still in the air to avoid that the soil conditions (e.g. a long-haired carpet) hinder the leg movement. Therefore a second handle is arranged in one embodiment of the invention that is fixed at the highest position of the movable handle on the column and that is slightly bigger than the latter. This makes it possible to loosen the movable handle so that the stand slides a bit further down and so that the fixed handle slides into the hand: you grab the fixed handle, the movable handle is free and the legs fold out. Now the stand can be deposited easily.

The fixed handle has a second advantageous function: It allows to lift the stand without the legs being folded in. This is especially pleasant when you only want to shift the stand a few centimeters, or for instance when you want to turn the stands' legs—around the vertical axis of the main column—into a certain position.

Also a mechanical or electrical switch that interrupts the connection of the movable handle to the leg mechanics temporarily can be used as a trigger for folding out the legs.

To adjust the device's position a magnetic ball joint is especially suitable: It has an particularly large swivelling range and can—the weight of the device being known—be laid out in such a way that it remains in every set position by friction and therefore does not have to be fixed by the user. The operation process thus only consists of an intuitive move to the desired position. The magnetical base can be integrated into the upper end of the main column for a better optical appearance.

Between the upper end of the main column and the device another advantageous embodiment of the invention a cantilever is located that enables a positioning of the device away from the longitudinal axis of the main column. Provided with a counterweight to the device the cantilever still enables a center of gravity in the vicinity of this axis.

The adjustment of height is achieved relatively easy by a telescopic-like composition of the main column (here: supporting telescope). There also, with known weight of the device, the friction between the telescope profiles can be adjusted in such a way that the user can move the stand stepless to the desired height and that the stand remains there.

To achieve a height adjustment of the stand a height adjustable connection is certainly necessary between the grasping area (as long as it is located in the advantageous vicinity of the device) on the upper end and the leg mechanics on the lower end of the main column. This can be done in several ways according to the invention.

In case of the electrical folding in and/or folding out of the legs e.g. a coiled cable can be used that balances the variable length of the main column. When using electronics a short radio link is also conceivable.

To achieve mechanical controlling of the legs by the handle, a kind of second telescope is possible (here: controlling telescope): A mechanism, that controls the leg mechanics in one state, and adjusts its own length in another state without influencing the leg mechanics. This can be reached for instance by connecting or detaching the profiles of the telescope from each other by the handle.

The lifting of the handle in its guideway leads to the connection of the profiles of the controlling telescopes whereby its lower profile gets lifted as well and folds in the legs by the differential motion to the lower profile of the supporting telescope. But if you do not grab the movable handle, but lift the upper profiles of both telescopes at the same time by grabbing a different place, both of the profiles of the controlling telescope remain separated so that an adjustment of length of the main column takes place.

For this purpose the connection of the profiles can take place by a pawl (belongs to the upper profile in this case) that engages to a gear rack (belongs to the lower profile in this case) as soon as the handle is lifted. This can be simply and robustly achieved by a gravity actuated pawl that sets down on a protrusion in the lowest position of the handle. This protrusion neutralizes the impact of gravity by holding up the pawl. It then engages while being lifted. In one advantageous embodiment the pawl is located flexibly behind the gear rack and encompasses it so that it is clamped by pulling up and leads to an increase of the bonding force with tensile stress between the profiles. Furthermore this arrangement can do without support on other profiles (e.g. of the supporting telescope), which helps to reduce friction.

Even easier to realize could be one embodiment of the invention that uses a clamping ring on the pole instead.

The controlling telescope can also in contrast separate the connection between the profiles while lifting the handle. In connection with the abovementioned leg that controls the leg mechanics by floor contact this feature can control e.g. a friction brake that only allows the legs to fold in when the movable handle has been used to lift the stand.

A different possibility to decide between height adjustment and detraction of the legs results when depending on the position of the movable handle the controlling and the supporting telescope are either connected or not.

Only the lifting of the handle with respect to its guideway releases the supporting telescope so that a differential motion between the telescopes takes place which causes the legs to fold in. A simultaneous lifting of both the upper telescope profiles leads to height adjustment instead.

The distinction can also take place because the mechanics always tries to fold in the legs, but this can be blocked by holding the folded out legs on the floor, because when you intend a heightening of the stand you intuitively keep hold of its lower portion. The movable handle then works e.g. against a spring that normally passes the force for the adjustment of the legs on to the controlling telescope. In case that the legs are blocked the spring gets tensioned until the movable handle bumps into the fixed handle. Thereby both telescopes are connected and move on together: the height of the stand is adjusted. When letting go at the end of this procedure the spring re-establishes the distance between both handles, which is needed for folding in the legs.

A third possibility to use the controlling telescope is to rotate it with respect to the supporting telescope for activating the leg mechanics. The advantage is that one tappet moving in a groove of the other profile is sufficient to pass on the movement in the controlling telescope. Thus it can be independent from the adjustment of height of the profiles to each other.

This mechanism can be applied particularly advantageously when folding out the legs is based on a rotary motion. This is possible e.g. by use of permanent magnets that control the legs by their attraction (and in another embodiment their repulsion). If you arrange e.g. as many permanent magnets as the stand has legs on a basically vertical axle in the inner of the main column, you can make sure by slightly rotating the axle that the magnetizable (or in another embodiment magnetic) elements of the legs are located either in the area of the magnetic fields or not, which causes the folding in and folding out depending on the arrangement.

By use of electrics and electronics such an impact can be advantageously reached by electromagnets.

The telescope profiles can be arranged with optical advantages into one another. For this purpose the use of tubes appear obvious, because they enable a simple appearance and also can be fitted inside one another easily.

To simplify folding in the legs when they have contact to the floor while lifting, one embodiment of the invention provides wheels or castors on the outer ends of the legs, whose axis is arranged horizontally and rectangular to the longitudinal axis of the legs. To make the contact with bounding vertical areas (e.g. walls, furniture etc.) less dangerous and less obstructive while lifting or lowering the stand it is generally advantageous when the wheels protrude that far that they also can roll down on these surfaces.

By use of electrics and electronics it is advantageous when a rechargeable energy storage is located in or by the stand. This energy storage can also be electrically connected to the device that is attached to it so that it can provide it with (if applicable additional) energy. Alternatively the energy storage of the device can power the stand as well.

Also the stand can be operated by control surfaces of the device. The device can use sensors and switches of the stand in the opposite direction. Operating the stand by the device attached to it (if applicable by means of an algorithm) can be particularly advantageous.

Various embodiments of the invention will now be described with reference to the accompanying schematic drawings in which:

FIG. 1 is a part of an embodiment of the invention in vertical section.

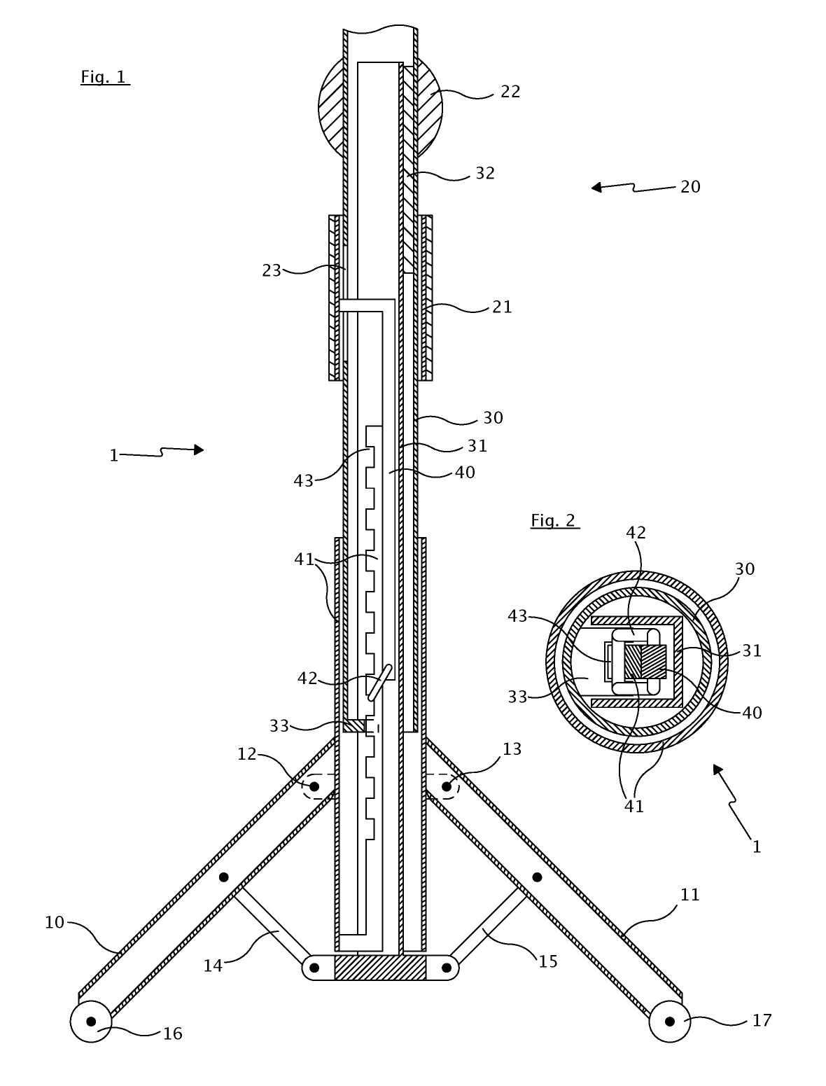

FIG. 2 is a horizontal cut through the main column of the same embodiment.

FIG. 3 is the second embodiment of the invention in vertical section.

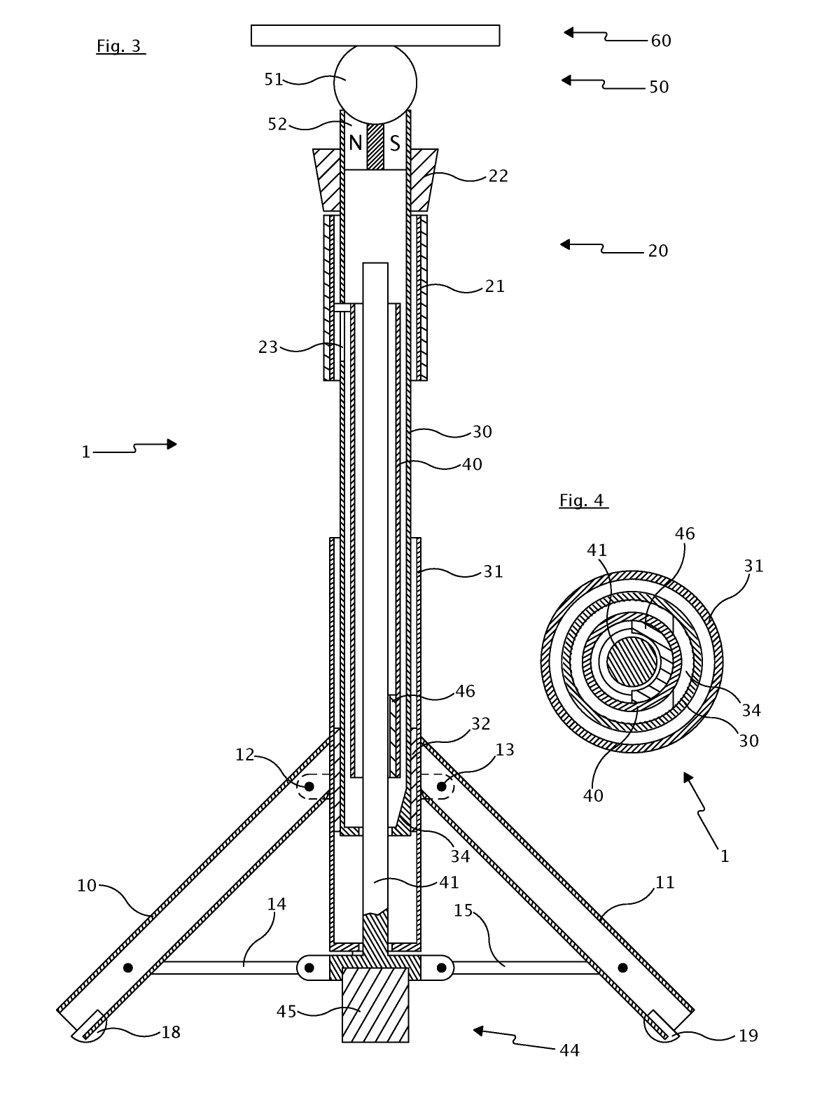

FIG. 4 is a horizontal cut through the main column of the same embodiment.

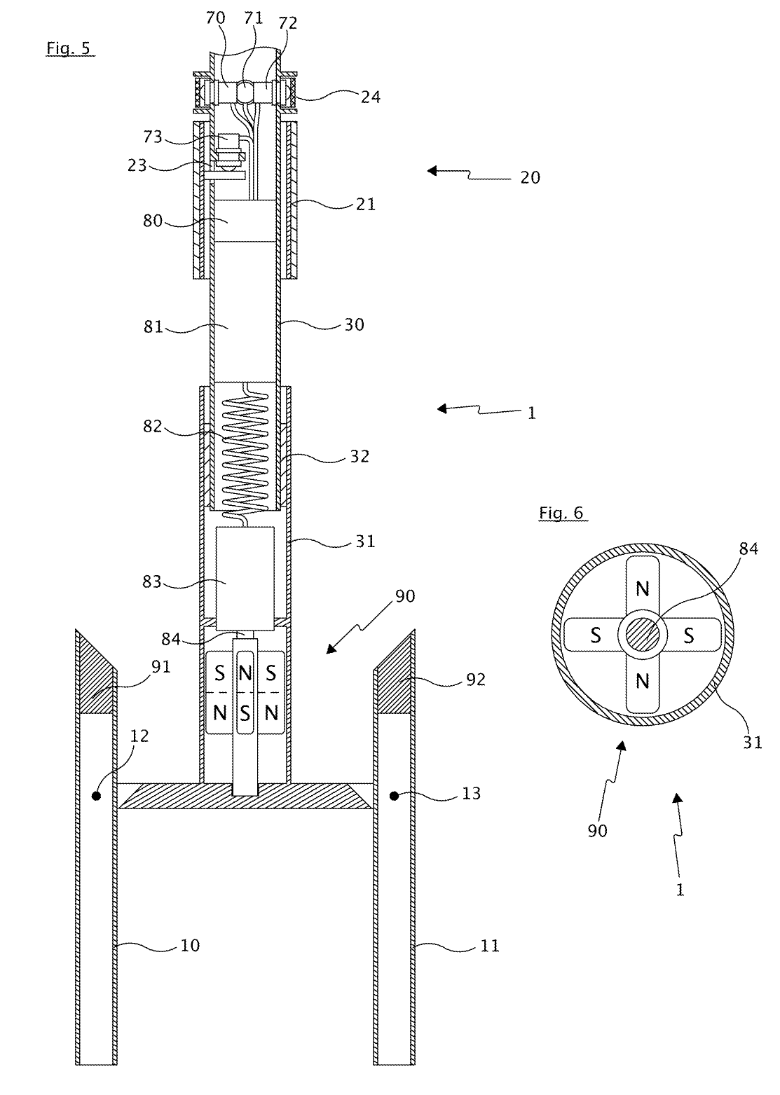

FIG. 5 is a part of the third embodiment of the invention in vertical section.

FIG. 6 is again a horizontal cut through the main column of the same embodiment.

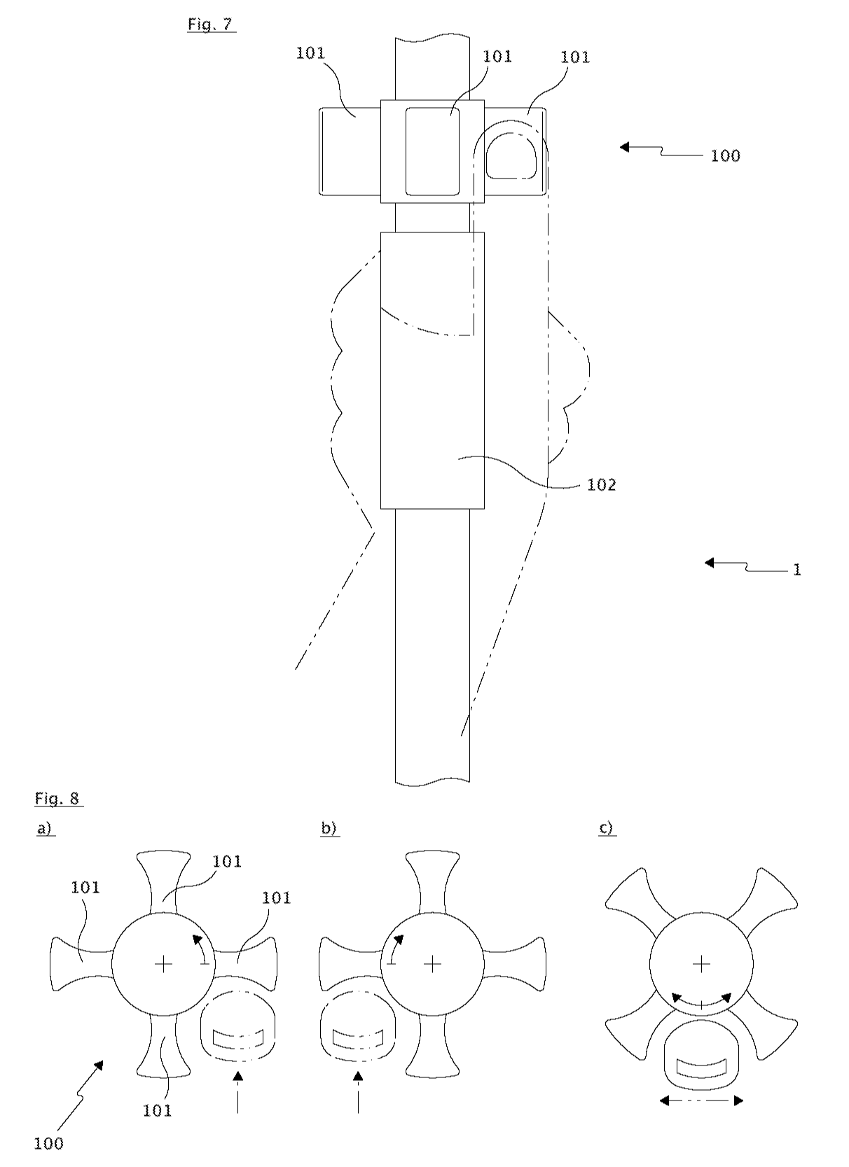

FIG. 7 is a switch with radially protruding actuation fins in a side view.

FIGS. 8 a)-c) are examples for the actuation of the switch of FIG. 7 with a thumb.

In each vertical section just two legs are featured exemplary.

In FIG. 1 you can see a stand according to the invention with a main column 1, the foldout legs 10 and 11, the grasping area 20, consisting of a movable handle 21 and a fixed handle 22. The device fixing is not shown here.

The movable handle 21—in this figure cylindrical—is moving in a guideway 23 that is located on the main column 1, the fixed handle 22—in this figure spherical—is fixed on it.

The supporting telescope consists of the upper profile 30 and the lower profile 31. In this embodiment, the upper profile 20 is a partly external tube; the lower profile 31 is an internal, left-opened u-profile. Both are coupled through an elastic friction surface 32, which is fixed on the lower profile 31. The controlling telescope consists of the upper profile 40 and the lower profile 41. In this embodiment, the upper profile 40 is an internal pole connected with the movable handle 21, to which the pawl 42 is articulately jointed by a horizontal hole. In the here shown lifted position of the movable handle 21, the pawl 42 engages in the gear rack 43, which is part of the lower profile 41, by the force of gravity. This lower profile 41 extends additionally as an external tube and establishes a connection to the upper leg hinges 12 and 13.

The upper profile 30 of the supporting telescope, which is the guideway 23 of the movable handle 21, features a protrusion 33 on its lower end on the inside that—in the lowest position of the movable handle 21 in its guideway 23—brings the pawl 42 in a horizontal position and thus ensures that the gear rack 43 can move freely during a height adjustment of the stand. If, on the contrary, the movable handle 21 is lifted with respect to its guideway 23, the pawl 42 engages to the gear rack 43 (as drawn) and lifts it and with it the whole lower profile 41 of the controlling telescope. This takes the upper leg hinges 12 and 13 which results in folding in the legs 10 and 11 into a mainly vertical position because they are connected in an articulated way through the struts 14 and 15 to the lower profile 31 of the supporting telescope, which does not change its height. Only now the movable handle 21 reaches the upper end of its guideway 23 and begins to lift the whole stand.

Wheels 16 and 17 are fixed on the lower ends of the legs 10 and 11.

FIG. 2 shows a horizontal cut of FIG. 1's embodiment, led through the main column 1 above the pawl 42, seen from the top. The external tube belongs to the lower profile 41 of the controlling telescope; the internal tube is the upper profile 30 of the supporting telescope. In it you can see the upper profile 40 of the controlling telescope (that is fixed on the handle 21, not shown here), which, on its lower end, carries the pawl 42 by its horizontal hole. In this embodiment, the pawl 42 is placed annularly around the inner part of the lower profile 41, which is featured as a gear rack 43, and engages in it. Below it is the protrusion 33 of the upper profile 30 of the supporting telescope. This reaches around the gear rack 43 on both sides and thus brings the pawl 42 in a horizontal position when lowered.

FIG. 3 shows a second embodiment of the stand according to the invention with the main column 1, two foldout legs 10 and 11, the grasping area 20 with a movable handle 21 and a fixed handle 22, as well as a magnetic ball joint 50 as a transition to the device fixing 60 (here just symbolized by a plate).

Here again the cylindrical movable handle 21 is moving on the main column 1 in its guideway 23 and the fixed handle 22, here cone-shaped, is fixed on the main column 1.

In this embodiment, the supporting telescope consists of the upper profile 30 and the lower profile 31, coupled through an elastic friction surface 31, which is fixed on the upper profile 30. Both are featured as tubes that build the external cover of the main column. On the lower profile 31 of the supporting telescope, the upper leg hinges 12 and 13 are fixed.

The controlling telescope has a floor stand 44 with an elastic element 45 that is part of the lower profile 41. The upper profile 40 is again connected with the movable handle 21.

The lower profile 41 is constructed as a pole that is guided through the tubular upper profile 40, which is furnished with a friction surface 46 on its lower end on one inner side. When the movable handle 21 is lifted with respect to its guideway 23 (as drawn here), the friction area 46 has no contact to the lower profile 41 of the controlling telescope. If the movable handle 21 is lifted further, it bumps into the upper end of its guideway 23 and lifts the whole stand. For the time being, the floor stand 44 and with it the lower profile 41 of the controlling telescope stay on the floor. Thus the struts 14 and 15 fold in the legs 10 and 11, because their upper hinges 12 and 13 are lifted with the stand.

If, on the contrary, the fixed handle 22 is used for lifting the stand, the movable handle 21 is located on the lower end of its guideway 23. Thereby the upper profile 40 of the controlling telescope makes contact with an inclined plane 34 on the lower edge of the upper profile 30 of the supporting telescope, which is also the guideway 23 of the movable handle 21. This inclined plane 34 presses the upper profile 40 of the controlling telescope against the lower profile 41 of the controlling telescope by its friction surface 46 and establishes thereby a friction coupling. When lifting the stand, the controlling telescope now blocks, so that the floor stand 44 is lifted immediately and the legs 10 and 11 do not fold in.

When lowering the stand with folded in legs 10 and 11, the floor stand 44 first touches the floor and slides the lower profile 21 of the controlling telescope in the upper profile 40, whereby the legs are folded out through the struts 14 and 15. The elastic element 45 just gives the force that is needed to fold out and is compressed in the end, so that the weight of the stand and the device in standing position rests on the legs 10 and 11 to a large extend.

If you want to adjust the height of the stand, you hold it intuitively at its lower portion and thus on the lower profile 31 of the supporting telescope. Thereby the leg mechanism is blocked and the legs 10 and 11 cannot fold in. Now you have to pull on top of the stand which is possible on the movable handle 21 or elsewhere, so on the fixed handle 22 or on the upper profile 30 of the supporting telescope. When pulling the fixed handle 22 or the upper profile 30 of the supporting telescope the friction in the controlling telescope—between the friction surface 46 and the lower profile 41—is switched on. Since this friction just has to deliver the little force to prevent the lower profile 41 with the leg mechanism from falling, it will not be much of a factor with respect to the higher friction in the supporting telescope—between the friction surface 32 and the lower profile 31—which has to be overcome for height adjustment. Therefore it does not hinder the height adjustment.

In this embodiment, floor protecting and friction-less skids 18 and 19 are installed on the lower ends of the legs 10 and 11.

The magnetic ball joint 50 as a connection between the main column 1 and the device fixing 60 in this embodiment consists of a magnetizable ball 51 and a permanent magnetic base 52, that is embedded in the upper end of the main column 1—in this embodiment in the upper profile 30 of the supporting telescope. The device fixing 60 is attached on the ball 51.

In FIG. 4 you can see a horizontal cut of the main column 1 out of FIG. 3, cut above the friction surface 46, seen from the top. The external tube is the lower profile 31 of the supporting telescope; the next inner tube is the upper profile 30 to it. This contains the inclined plane 34. The internal tube is the upper profile 40 of the controlling telescope, which is connected to the movable handle 21 (not shown here). Fixed in the inside of the tube is the semicircular friction surface 46. The central pole is the lower profile 41 of the controlling telescope, which is connected to the floor stand 44 (not shown here). When lowering the movable handle 21 (not shown) the upper profile 40 of the controlling telescope also lowers, comes down to the inclined plane 34 with its lower edge and is pressed on the pole 41 with its friction surface 46, whereby the leg mechanism is blocked.

FIG. 5 shows a third embodiment of the invention with the main column 1, folded in legs 10 and 11 and the grasping area 20 with a movable handle 21 and an annular switch 24. The device fixing is not shown here.

Also here the cylindrical movable handle 21 moves in a (shorter) guideway 23 on the main column 1. The annular switch 24 extends around the main column 1.

In this embodiment of the stand according to the invention the supporting telescope consists of the upper profile 30 and the lower profile 31 that are both tubes and build the cover of the main column 1. They are coupled through the friction surface 32 that is fixed on the upper profile 30. The legs 10 and 11 are fixed through the hinges 12 and 13 on a disc-shaped widening of the lower profile 21.

In this embodiment, the controlling of the leg mechanism does not take place through a controlling telescope but through electricity and electronics. In the grasping area 20 there are several electric switches 70, 71 and 72 that are connected through an external annular switch area 24. Below there is an electric switch 73 that is activated by the movable handle 21.

When lifting the stand with the movable handle 21, the switch 73 causes the legs 10 and 11 to fold in automatically. Before the lowering of the stand the legs 10 and 11 are caused to fold out by the actuation of the annular switch 24.

In a control unit 80, the signals of the switches are translated into motor commands. According to these commands, the motor 83 is supplied with voltage out of the rechargeable accumulator 81 by a coiled cable 82, which enables the length compensation during a height adjustment of the stand.

FIG. 6 again shows a horizontal cut of the main column 1 of the embodiment of the previous drawing, cut above the magnet arrangement 90, seen from the top. The external tube is the lower profile 31 of the supporting telescope. In its interior the magnet arrangement 90 is fixed on a rotatable axle 84.

FIG. 7 shows a part of the main column 1 of the stand according to the invention with a handle 102, which is gripped by a user's left hand in the presented example. In this hand position the user is able to lift the stand at the handle 102. Directly above the handle 102 an annular switch 100 is located, which features four mainly radial protruding actuation fins 101. In this arrangement the switch 100 can be activated easily by the thumb of the hand that grasps the handle 102, namely by exerting force on one of the actuation fins 101 with the thumb in a tangential direction. The rotation area of the second switch 100 can be chosen relatively small and for example just be in a range of 1° to 15°. By activating the second switch 100 for example a height adjustment can be activated. The second switch 100 is as well applicable for other functions, e.g. for folding out the standing area.

FIG. 8 exemplarily shows views on the arrangement of FIG. 7 from above. In the arrangement of the thumb according to the FIG. 8 a) the actuation fin 101 on the right can especially be moved forward easily to cause a rotation of the second switch 100 contra clockwise.

In the example of FIG. 8 b)—which can especially be useful for a right-handed user—the actuation fin 101 on the left can equally easily be moved forward, which leads to a rotation of the second switch 100 clockwise.

In the example of FIG. 8 c) the thumb is located on the front between both—in the drawing angularly leading downwards—actuation fins 101. In this case an optionally rotation of the switch clockwise or contra clockwise can be caused by a lateral movement of the thumb.

An especially advantageous feature on the second switch with mainly radial protruding actuation fins 101 is that the user always finds a comfortable operating position, regardless of which side the user grasps the stand from. This applies equally for right-handed and left-handed users.

Various embodiments of the stand according to the invention will now be summarized in numbered paragraphs:
1. A stand that can be brought from a state with a large standing area into a state with a small horizontal expansion by folding in the standing area, wherein at least one grasping area (20) (defined for all following paragraphs as the area that the grasping hand—while holding the stand—takes, including the area it can reach with every single finger without releasing the stand) that is used for lifting the stand, also enables the activation of the folding in of the standing area and/or at least one grasping area that is used for depositing the stand, also enables the activation of the folding out of the standing area.
2. Stand according to paragraph 1, wherein both grasping areas (20) are identical.
3. Stand according to one of the paragraphs 1 to 2, wherein the change of the standing area happens using electricity and/or electronics.
4. Stand according to paragraph 3, wherein exists an electrical or mechanical switch (24, 70, 71, 72, 73) in the respective grasping area (20) for one or both of said activations.
5. Stand according to one of the paragraphs 1 to 4, wherein one or both changes of the standing area are automatically (without any further actions from the user) activated while using the respective grasping area (20) for lifting or depositing the stand.
6. Stand according to paragraph 5, wherein folding in the standing area is activated by the detection of lifting off the floor.
7. Stand according to paragraph 6, wherein a sensor, which sends electrical signals, detects the lifting off the floor.
8. Stand according to one of the paragraphs 6 to 7, wherein the lifting from the floor is detected by the difference movement of two stand sections, of which one stands on the floor and the other one is lifted by the user's hand.
9. Stand according to paragraph 8, wherein the floor standing section (41, 44, 45) is considerably smaller than the rest of the stand.
10. Stand according to one of the paragraphs 8 to 9, wherein the section (21, 40) that is lifted by the user's hand is considerably smaller than the rest of the stand.
11. Stand according to paragraph 10, wherein said section (21, 40) that is lifted by the user's hand is at least partly identical with a handle (21), which is a part of the grasping area (20) for lifting the stand.
12. Stand according to paragraph 5, wherein folding out the standing area is activated by detection of the approach to the floor.
13. Stand according to paragraph 12, wherein a sensor that sends electrical signals can detect the approach to the floor.
14. Stand according to paragraph 12, wherein the approach to the floor is detected by the differential movement of two stand sections, of which one stands on the ground and the other one is dropped by the user's hand.
15. Stand according to paragraph 14, wherein the floor standing section (41, 44, 45) is considerably smaller than the rest of the stand.
16. Stand according to one of the paragraphs 1 to 15, wherein at least one handle (21, 22) is built primarily vertically rotationally symmetric or, with regard to the gripping position of the hand, approximately rotationally symmetric.
17. Stand according to one of the paragraphs 1 to 16, wherein at least one electrical or mechanical switch (24) is built primarily vertically rotationally symmetric or, with regard to the gripping position of the hand, approximately rotationally symmetric.
18. Stand according to one of the paragraphs 1 to 17, wherein above at least one movable handle (21) at least one fixed handle (22) is installed.
19. Stand according to paragraph 18, wherein the vertical central axis of both handles (21, 22) is identical.
20. Stand according to one of the paragraphs 18 or 19, wherein said handles (21, 22) feature such a distance between each other that both can be hold with one hand while said movable handle (21) is in its highest position.
21. Stand according to one of the paragraphs 18 to 20, wherein said fixed handle (22) features a larger diameter than said movable handle (21).
22. Stand according to one of the paragraphs 18 to 21, wherein said fixed handle (22) is spherical.
23. Stand according to one of the paragraphs 18 to 21, wherein said fixed handle (22) is cone-shaped.
24. Stand according to paragraph 23, wherein said cone (22) has its larger diameter at the top.
25. Stand according to paragraph 11 and one of the paragraphs 18 to 24, wherein said movable handle (21) is at least partly identical with said lifted section (21, 40).
26. Stand according to one of the paragraphs 18 to 25, wherein the lifting at said fixed handle (22) causes no change of the standing area.
27. Stand according to one of the paragraphs 1 to 26, wherein the device fixing (60) is connected with the rest of the stand by a ball joint (50).
28. Stand according to paragraph 27, wherein said ball joint (50) holds together through magnetic force.
29. Stand according to paragraph 28, wherein said ball joint (50) consists of a magnetic base (52) and a magnetizable ball (51).
30. Stand according to one of the paragraphs 27 to 29, wherein said ball (51) of said ball joint (50) is attached on said device fixing (60) and said base (52) is attached on the rest of the stand.
31. Stand according to one of the paragraphs 27 to 29, wherein the base of said ball joint (50) is attached on said device fixing (60) and the ball is attached on the rest of the stand.
32. Stand according to one of the paragraphs 1 to 31, wherein the stand features a section (1) that establishes a connection between the folding mechanism of the standing area and the transition (50) to the device fixing (60) of the stand.
33. Stand according to paragraph 32, wherein at least one movable handle (21) has the same central axis as the main column (1).
34. Stand according to paragraph 32 and one of the paragraphs 1 to 33, wherein at least one movable handle (21) uses said main column (1) as a motion guideway (23).
35. Stand according to paragraph 32 and one of the paragraphs 1 to 34, wherein at least one fixed handle (22) has the same central axis a the main column (1).
36. Stand according to paragraph 32 and one of the paragraphs 1 to 36, wherein at least one fixed handle (22) is installed on the main column (1).
37. Stand according to paragraph 27, 32 and one of the paragraphs 1 to 26, wherein said base (52) of said ball joint (50) has the same central axis as said main column (1).
38. Stand according to paragraph 27, 32 and one of the paragraphs 1 to 37, wherein said base (52) of said ball joint (50) is embedded in said main column (1).
39. Stand according to one of the paragraphs 1 to 38, wherein said device fixing (60) contains a boom that enables the positioning of the device considerably outside the central axis of the stand.
40. Stand according to paragraph 29, wherein the boom features a counterweight to compensate the weight of the device at least partly.
41. Stand according to paragraph 32 or one of the paragraphs 1 to 40, wherein said main column (1) consists primarily of one profile or an arrangement of profiles that transfers the force that is needed to carry the device (30, 31) on the stand (hereinafter referred to as supporting profile) and an electric and/or electronic mechanism (70, 71, 72, 73, 80, 81, 82, 83) that manages the changes of the standing area.
42. Stand according to paragraph 32 and one of the paragraphs 1 to 40, wherein said main column (1) consists primarily of two profiles or two arrangements of profiles, of which one transfers the force that is needed to carry the device (30, 31) on the stand (hereinafter referred to as supporting profile) and the other transfers the force to change the standing area and/or controls it (40, 41) (hereinafter referred to as controlling profile).
43. Stand according to one of the paragraphs 1 to 42, wherein the stand is height-adjustable.
44. Stand according to one of the paragraphs 32 to 43, wherein the height adjustment is made by lengthening or shortening of said main column (1).
45. Stand according to one of the paragraphs 43 to 44, wherein the height adjustment happens steplessly.
46. Stand according to one of the paragraphs 43 to 45, wherein the height adjustment takes place without separate actuation of locking elements such as locking screws, locking flaps or the like.
47. Stand according to one of the paragraphs 43 to 46, wherein the height adjustment takes place using electricity and/or electronics.
48. Stand according to one of the paragraphs 43 to 47, wherein at least one grasping area (20) keeps a fixed distance to said transition (50) between said device fixing (60) and the rest of the stand when adjusting the height.
49. Stand according to one of the paragraphs 41 to 42 and to one of the paragraphs 43 to 48, wherein the supporting profile consists of a pair of profiles (30, 31) that interact telescopically (hereinafter referred to as supporting telescope).
50. Stand according to paragraph 42 and one of the paragraphs 43 to 48, wherein the controlling profile consists of a pair of profiles (40, 41) that interact telescopically (hereinafter referred to as controlling telescope).
51. Stand according to one of the paragraphs 42 to 50, wherein at least two of the profiles (30, 31, 40, 41) of said main column (1) have the same central axis.
52. Stand according to one of the paragraphs 42 to 51, wherein one or several profiles are tubes (30, 31, 40, 41) that contain one or several further profiles.
53. Stand according to one of the paragraphs 49 to 52, wherein the profiles of said supporting telescope (30, 31) are coupled through an electric actuator.
54. Stand according to one of the paragraphs 49 to 52, wherein the profiles of said supporting telescope (40, 41) are coupled through friction (32).
55. Stand according to one of the paragraphs 50 to 54, wherein the profiles of said controlling telescope (40, 41) are coupled through friction (46).
56. Stand according to one of the paragraphs 54 to 55, wherein the force, up to which the friction of both telescopes together blocks their movement, is greater than 90% of the weight force of the stand together with the device fixed on it.
57. Stand according to one of the paragraphs 50 to 56, wherein the profiles of the controlling telescope are coupled through tappets against rotation around the common longitudinal axis.
58. Stand according to one of the paragraphs 50 to 57, wherein the profiles of the controlling telescope can be connected and loosened by a switchable mechanical device (33, 34, 42, 43, 46) (hereinafter referred to as steering mechanism).
59. Stand according to paragraph 58, wherein said steering mechanism (33, 34, 42, 43, 46) is controlled by the position of a movable handle (21) with respect to its guideway (23).
60. Stand according to one of the paragraphs 58 to 59, wherein said steering mechanism (33, 42, 43) connects the upper (40) and the lower profile (41) of the controlling telescope frictionally as soon as said movable handle (21) is lifted for a short distance with respect to its guideway (23).
61. Stand according to one of the paragraphs 58 to 59, wherein said steering mechanism (34, 46) disconnects the upper (40) from the lower profile (41) of the controlling telescope frictionally as soon as said movable handle (21) is lifted for a short distance with respect to its guideway (23).
62. Stand according to paragraph 11 and one of the paragraphs 59 to 60, wherein said movable handle (21) is at least partly identical with said lifted section (21, 40).
63. Stand according to one of the paragraphs 58 to 62, wherein said steering mechanism (33, 42, 43) does not exert any important horizontal forces on the profiles of said supporting telescope (30, 31).
64. Stand according to one of the paragraphs 58 to 63, wherein said steering mechanism consists of a gear rack (43) and a pawl (42), whose engagement in said gear rack (43) is switchable.
65. Stand according to paragraph 64, wherein said pawl (42) and its fixing is formed in a way that said steering mechanism is pulled closer to said gear rack (43) when under tensile stress.
66. Stand according to paragraph 60 and one of the paragraphs 64 to 65, wherein said pawl (42) is connected to said movable handle (21) through one or several hinges and in the lowest position of said movable handle (21) with respect to the profile (30), which is its guideway (23), said pawl (42) touches down on a protrusion (33) of said profile (30), moving it out of said gear rack (43).
67. Stand according to paragraph 60 and one of the paragraphs 64 to 65, wherein said pawl (42) is connected to said movable handle (21) through one or several hinges and in the lowest position of said movable handle (21) with respect to the profile (30), which is its guideway (23), it reaches a section of the same profile (30), which magnetically moves it out of said gear rack (43).
68. Stand according to one of the paragraphs 58 to 63, wherein said steering mechanism consists of a pole and a clamping ring, whose clamping effect on the pole is switchable.
69. Stand according to paragraph 68, wherein said clamping ring and its fixing are formed in a way, that its clamping effect is reinforced when the steering mechanism is under tensile stress.
70. Stand according to paragraph 60 and one of the paragraphs 68 to 69, wherein said clamping ring is connected to said movable handle (21) through one or several hinges and in the lowest position of said movable handle (21) with respect to the profile (30), which is its guideway (23), said clamping ring touches down on a protrusion (33) of said profile (30), moving it out of its clamping position on the pole.
71. Stand according to one of the paragraphs 58 to 63, wherein said steering mechanism consists of a rope and a brake mechanism, whose braking of the rope is switchable.
72. Stand according to one of the paragraphs 58 to 63, wherein the steering mechanism consists of two friction surfaces (41, 46), whose contact is switchable.
73. Stand according to one of the paragraphs 58 to 72, wherein another steering mechanism interrupts temporarily the connection between said movable handle (21) and the steering mechanism.
74. Stand according to one of the paragraphs 1 to 73, wherein an elastic element between at least one movable handle (21) and said profile (30), which is its guideway (23), has the effect that the exertion of different forces on said handle (21) bring it into different positions with respect to its guideway (23), which is used for controlling the change of the standing area.
75. Stand according to paragraph 54, 55 and one of the paragraphs 56 to 57 and 74, wherein the position of said movable handle (21) with respect to its guideway (23) decides whether the telescopes, whose respective profiles are friction-coupled on their part, couple or not.
76. Stand according to paragraph 75, wherein said coupling is made by catching the fixed (22) through the movable handle (21) by direct contact.
77. Stand according to paragraph 75, wherein the coupling is made by a pawl.
78. Stand according to paragraph 77, wherein said pawl is controlled magnetically.
79. Stand according to one of the paragraphs 75 to 78, wherein the telescopes are coupled without a lifting force that is acting on said movable handle (21), are uncoupled by an acting lifting force below the total weight of the stand together with the fixed device and are coupled again by an acting lifting force considerably higher than said weight.
80. Stand according to paragraph 54, 55 and one of the paragraphs 56 to 57, 74 to 75 and 79, wherein the self-friction-coupled telescopes can be coupled by an electrical actuator.
81. Stand according to paragraph 57, wherein the motion of said movable handle (21) with respect to its guideway is translated into a rotation of the controlling telescope around its longitudinal axis.
82. Stand according to paragraph 11 and 81, wherein said movable handle (21) is at least partly identical with the mentioned lifted section (21, 40).
83. Stand according to paragraph 15, 61 and 72, wherein the lower profile (41) of the controlling telescope is at least partly identical with the mentioned floor standing section (41, 44, 45).
84. Stand according to paragraph 83, wherein said profile (41) can shorten elastically between its contact patch and the connection with the folding mechanism of the standing area.
85. Stand according to one of the paragraphs 1 to 84, wherein the changing of the standing area is mainly the result of a changing of the legs' (10, 11) position with respect to said main column (1).
86. Stand according to paragraph 85, wherein the change of the leg's position (10, 11) occurs by an electric actuator (83).
87. Stand according to one of the paragraphs 85 to 86, wherein the legs (10, 11) are connected with the lower profile (31, 41) through a hinge with a mainly horizontal axis (12, 13), as well as in a distance to it jointed articulately with a strut (14, 15) that again in a distance to it is jointed articulately with the lower profile (31, 41) of the other telescope.
88. Stand according to paragraph 87, wherein said legs (10, 11) are connected through said hinge (12, 13) to the controlling telescope (41) and said struts (14, 15) are connected through a hinge to the supporting telescope (31).
89. Stand according to paragraph 85, wherein a magnet arrangement (90) causes said change of position by influencing one section (91, 92) of every leg (10, 11) magnetically.
90. Stand according to paragraph 89, wherein the magnets are at least partly electromagnets.
91. Stand according to paragraph 89, wherein an electric actuator (83) influences said magnet arrangement (90) mechanically (84).
92. Stand according to paragraph 89, wherein the controlling telescope influences said magnet arrangement (90) mechanically.
93. Stand according to one of the paragraphs 89 to 92, wherein said magnet arrangement (90) related to its effect on said legs (10, 11) has at least two states; at least one of them attracts said leg section (91, 92) magnetically, at least one other is magnetically neutral.
94. Stand according to one of the paragraphs 89 to 92, wherein said magnet arrangement (90) related to its effect on said legs (10, 11) has at least two states; at least one of them attracts said leg section (91, 92) magnetically, at least one other repels it magnetically.
95. Stand according to one of the paragraphs 85 to 94, wherein said legs (10, 11) have a skid out of floor protecting and friction-less material (18, 19) on its standing point that touch the floor at least in the leg position that generates the largest standing area of the stand.
96. Stand according to one of the paragraphs 85 to 94, wherein said legs (10, 11) have a wheel or a caster out of floor protecting material (18, 19) on its standing point that touch the floor at least in the leg position that generates the largest standing area of the stand.
97. Stand according to paragraph 96, wherein said wheel or caster (16, 17) is installed in a way that it constitutes the farthest protruding point in a horizontal direction—except from the device fixing—of the stand, at least in the leg position that generates the largest standing area of the stand.
98. Stand according to one of the paragraphs 96 to 97, wherein said wheel or caster (16, 17) feature a horizontal rotation axis that is rectangular to the longitudinal axis of the particular leg (10, 11).
99. Stand according to one of the paragraphs 1 to 98, wherein a rechargeable electric energy storage (81) is installed solidly on or in the stand.
100. Stand according to one of the paragraphs 1 to 99, wherein said rechargeable electric energy storage (81) can be installed optionally on or in the stand.
101. Stand according to one of the paragraphs 99 to 100, wherein the rechargeable electric energy storage (81) powers at least a part of the stand's electricity/electronics.
102. Stand according to one of the paragraphs 99 to 101, wherein the rechargeable electric energy storage (81) powers at least temporarily the device fixed on the stand.
103. Stand according to one of the paragraphs 1 to 102, wherein the device fixed on the stand powers at least a part of the stand's electricity/electronics.
104. Stand according to one of the paragraphs 1 to 103, wherein at least one sensor on the stand provides data to the device fixed on the stand.
105. Stand according to one of the paragraphs 1 to 104, wherein the operating areas of the device fixed on the stand can be used at least temporarily for controlling the functions of the stand.
106. Stand according to one of the paragraphs 1 to 105, wherein the device fixed on the stand controls the functions of the stand.

1-29. (canceled)

30. A stand having a standing area that can be folded in and out, including a handle to lift the stand with one hand, whereby a retraction and/or folding out of said standing area can be activated within a grasping area (20) that is reachable with one hand grasping said handle.

31. The stand according to claim 30, wherein the folding in of said standing area can be triggered automatically when lifting the stand.

32. The stand according to claim 30, whereby said handle is movable and formed to fold in the standing area when lifting the stand at the movable handle (21).

33. The stand according to claim 30, including a device fixing (60) that is used to carry a device, and a main column (1), whereby the handle is located in the area of said main column (1).

34. The stand according to claim 32, wherein the stand has a guideway (23), in which said movable handle (21) is moving, so that the stand firstly stands still when lifting the stand at said movable handle (21) and said movable handle (21) moves relatively to the stand.

35. The stand according to claim 32, wherein said movable handle (21) is formed to exert a driving force when moving said movable handle (21) relatively to the stand, which causes the folding in of the standing area.

36. The stand according to claim 32, wherein the standing area folds out when letting go said movable handle (21).

37. The stand according to claim 32, wherein the stand has a second handle (22) that is used for holding the stand to fold out the standing area or to leave it in a folded out state.

38. The stand according to claim 37, wherein said second handle (22) is located above the movable handle (21).

39. The stand according to claim 37, wherein said second handle (22) has a greater maximum diameter than said movable handle (21).

40. The stand according to claim 33, wherein said main column (1) has a supporting profile arrangement that supports a device which is located on the stand, and a controlling profile arrangement that transfers a force to fold in and/or fold out the standing area.

41. The stand according to claim 40, wherein the supporting profile arrangement consists of two profiles (30, 31) that are coupled by friction.

42. The stand according to claim 40, wherein said controlling profile arrangement is formed to transfer forces in a vertical direction without exerting force to other stand elements in a horizontal direction.

43. The stand according to the claim 40, wherein the controlling profile arrangement consists of two profiles (40, 41) and a mechanical connection device through which said two profiles (40, 41) are connected and can be loosened from each other.

44. The stand according to claim 43, wherein the connection device consists of a gear rack (43) and a pawl (42) that engages to said gear rack.

45. The stand according to claim 44, wherein said pawl (42) is connected to the movable handle (21) through one or several hinges and—in the lowest position of said movable handle (21)—touches down on a protrusion (33) that is moving said pawl (42) out of said gear rack (43).

46. The stand according to claim 40, wherein said controlling profile arrangement is rotatable with respect to said supporting profile arrangement and said retraction and/or folding out can be activated by a rotation of the controlling profile arrangement with respect to the supporting profile arrangement.

47. The stand according to claim 30, wherein said standing area is formed by foldout legs (12, 13).

48. The stand according to claim 47, wherein said legs have wheels (16, 17) or castors on their outer ends.

49. The stand according to claim 33, wherein said device fixing (60) has a magnetic ball joint (50).
